(19) United States
(12) Patent Application Publication
(10) Pub. No.: US 2008/0048993 A1
(43) Pub. Date: Feb. 28, 2008

(54) Display apparatus, display method, and computer program product

(76) Inventor: Takanori Yano, Kanagawa (JP)

Correspondence Address: DICKSTEIN SHAPIRO LLP, 1825 EYE STREET NW, Washington, DC, 20006-5403, US

(21) Appl. No.: 11/889,437

(22) Filed: Aug. 13, 2007

(30) Foreign Application Priority Data
Aug. 24, 2006 (JP) 2006-228480

(51) Int. Cl. G06F 3/041

(52) U.S. Cl. 345/173

(57) ABSTRACT

A display apparatus includes a display unit that includes a first area that stretches along an outer periphery of the display unit and a second area in which an image can be displayed. In the first area, a plurality of sensors that senses a finger touch is arranged. A pattern determining unit determines a pattern of the finger touch based on a sequence and a position of the finger touch obtained as result of sensing by the sensors. An orientation determining unit determines orientation of an image to be displayed on the second area based on the pattern of the finger touch. A control unit displays an image on the second area in the determined orientation.

### CROSS-REFERENCE TO RELATED APPLICATIONS

The present application claims priority to and incorporates by reference the entire contents of Japanese priority document, 2006-228480 filed in Japan on Aug. 24, 2006.

### BACKGROUND OF THE INVENTION

1. Field of the Invention

The present invention relates to a technology for a display apparatus. More particularly, the present invention relates to an electronic paper device and a method of controlling a way of displaying an image on the electronic paper device.

2. Description of the Related Art

Recently, flexible display devices have attracted attentions as one of display media. One of such flexible display devices is an electronic paper device that is expected as a new medium alternative to paper, and it is attempted to improve its usability and develop a new interface.

A typical electronic paper device is a thin-film display device in which a display layer and a film-type control layer for controlling the display layer are integrated into one unit. A display method for displaying an image on the display layer includes a microcapsule electrophoresis and a twist ball method. Those methods have high resolution comparable to that of an electrophotographic developing system for a printing machine, high memory capacity of the display layer, and high flexibility.

In terms of usability, the electric paper device, on contrary to the fixed displayer, is easy to handle literally just like paper, portable, and has no restriction so that the device can be placed in all orientations by changing the manner of holding it (orientation at which it is held), unlike a fixed display.

The electronic paper device as a display apparatus which is easy to carry allows the user to hold it freely. Therefore, the control for the display method according to the manner of holding it requires estimation of the manner of holding it with less erroneous estimation. For example, Japanese Patent Application Laid-Open Nos. H11-143604, H10-301695, 2004-226715; and H05-160938 disclose some known technologies about the control for the display method.

The electronic paper device as a recently developed display apparatus allows the user to easily hold it (or place it) or to change the manner of holding it (or to change the manner of placing it). Therefore, it is desirable that the vertical or the horizontal orientation of the electronic paper device upon display of an image thereon is changed according to the manner of holding it.

As is seen in the fixed display device, however, it is general that the portrait or landscape orientation of an image to be displayed on the display screen of the electronic paper device is determined with respect to the electronic paper device.

Japanese Patent Application Laid-Open No. H11-143604 discloses the technology for switching the display orientation of the screen of a portable information terminal depending on how the user holds the terminal. This technology is targeted for a small portable information terminal, and allows the portable terminal to surely recognize the manner of holding it by limiting the position being held.

Japanese Patent Application Laid-Open No. H10-301695 discloses the technology related to an interface function which gives an operation instruction through finger operation. This technology is related to a state detection method. More specifically, in this method, a sensor is provided so as to detect the state of an item which can be held with one hand and detect whether there is one or more contacts on the side faces of the item, and the state of the portable terminal is determined according to a position of the sensor that detects the contact.

Alternatively, the technology is related to a state detection method of an item which can be held with one hand. More specifically, in this method, a gravity sensor is provided in the item so as to detect the direction of gravity, and the state of the item is detected according to the detected direction of the gravity.

Another technology related to a portable terminal device is also disclosed. The portable terminal device includes a display controller that automatically changes an orientation to be displayed on the display unit according to the state of the portable terminal detected by using the state detection method.

In Japanese Patent Application Laid-Open No. H10-301695, the target is limited to a portable terminal device including a display screen of a size to fit in one hand. The manner of holding the display apparatus with such a display size is not always the manner that can be thought of when it is held with one hand. Because the orientation of the display apparatus can be easily changed by turning or tilting the user's wrist.

Furthermore, because the display apparatus can be held with one hand, fingers may come in contact with many faces thereof. Therefore, in an example of Japanese Patent Application Laid-Open No. H10-301695, it is configured to provide a guide groove to instruct a position where it is normally held, or to provide a portion with different texture from that of other portions.

Japanese Patent Application Laid-Open No. 2004-226715 discloses a portable display device which is provided with a tilt measurement unit to detect a change in its posture due to a tilt with respect to a vertical orientation of its casing, and which controls a display orientation of a rear liquid crystal display so that an “array direction of characters” is most appropriate for the user according to the change in its posture.

As another conventional technology, Japanese Patent Application Laid-Open No. H05-160938 discloses a technology of changing a display orientation of a touch panel with a liquid-crystal display function provided on the front face of a device body, by pressing a “change key” so that the user can easily operate the touch panel.

To change the display orientation by pressing an installed switch such as a key and a button, a series of procedure has to be performed in such a manner that the user checks its state and starts using it. As a result, the display orientation cannot quickly be changed, which does not allow users to be provided with a user-friendly interface.

However, when an electronic paper device has a characteristic such that a high degree of freedom is provided in a portion where it is held or in the manner of holding it, which is assumed in the present invention, the electronic paper device may sometimes be held only temporarily. Therefore, it may be better not to decide the display orientation even if a certain manner of holding it is temporarily detected. The concept of Japanese Patent Application Laid-Open No. H11-143604 is not tied to prevention of erroneous estimation that may occur when it is estimated how the user intends to hold it based on momentary detection.

In Japanese Patent Application Laid-Open No. H10-301695, limitation of the position to be held causes the manner of freely holding the electronic paper device to be restricted, and this case does not ensure that the device can be freely and readily handled, which is undesirable. As for the electronic paper of a large size, it is undesirable to narrow an area where it is held.

Japanese Patent Application Laid-Open No. 2004-226715 discloses the technology of controlling the display, in which the display orientation is optimized corresponding to the tilt of the casing. Because the electronic paper device can be easily carried and freely held with hand, how the device is held needs to be estimated if the display method is controlled according to the manner of holding it. In the conventional technologies, the manner of holding it is limited to specific manners, and thus, the following cases are not thought of, that is, a case of changing the manner of holding it, or a case where the same manner of holding it is continued.

### SUMMARY OF THE INVENTION

It is an object of the present invention to at least partially solve the problems in the conventional technology.

According to an aspect of the present invention, a display apparatus includes a display unit that includes a first area that stretches along an outer periphery of the display unit, a plurality of sensors that senses a finger touch being arranged in the first area; and a second area in which an image can be displayed; a pattern determining unit that determines a pattern of the finger touch based on a sequence and a position of the finger touch obtained as result of sensing by the sensors; and an orientation determining unit that determines orientation of an image to be displayed on the second area based on the pattern of the finger touch; and a control unit that displays an image on the second area in the orientation determined by the orientation determining unit.

According to another aspect of the present invention, there is provided a method of displaying an image on a display apparatus. The display apparatus including a display unit that includes a first area that stretches along an outer periphery of the display unit and a second area in which an image can be displayed. The method includes sensing a finger touch by a plurality of sensors that is arranged in the first area; first determining including determining a pattern of the finger touch based on a position and a duration of the finger touch obtained as result of the sensing; second determining including determining orientation of an image to be displayed on the display apparatus based on the pattern of the finger touch; and displaying an image on the second area in the orientation determined at the second determining.

According to still another aspect of the present invention, a computer program product that includes a computer-readable recording medium that stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a display apparatus according to a first embodiment of the present invention;

FIG. 2 is a block diagram of a modification of the display apparatus shown in FIG. 1;

FIG. 3 is a block diagram of a first example of a memory shown in FIG. 1;

FIG. 4 is a block diagram of a second example of the memory shown in FIG. 1;

FIG. 5 is a block diagram of an operation sensing unit shown in FIG. 1;

FIG. 6 is a schematic diagram of a display area of a display unit shown in FIG. 1;

FIG. 7 is a detailed schematic diagram of the display unit shown in FIG. 6;

FIGS. 8A to 8E are schematic diagrams for explaining a display control performed by the display apparatus shown in FIG. 1;

FIGS. 9A to 9C are schematic diagrams for explaining display control performed by the display unit based on result of sensing in a finger-contact sensing area;

FIGS. 10A to 10C are schematic diagrams for explaining another display control performed by the display unit based on result of sensing in the finger-contact sensing area;

FIG. 11 is a flowchart of the process of controlling the display orientation (portrait or landscape orientation) based on a finger contact position performed by the display apparatus;

FIG. 12 is a flowchart of the display control process performed by the display apparatus based-on a finger operation;

FIG. 13 is a contact-pattern table including a finger contact pattern, a contact edge, and a content of an operation;

FIG. 14 is a flowchart of the display control process performed by the display apparatus based on a finger contact sequence or a contact time;

FIGS. 15A to 15D are schematic diagrams for explaining a sequence of a finger-contact sensing process, a display-orientation (portrait or landscape orientations) control process, and a display-size adjusting process;

FIGS. 16A to 16C are schematic diagrams for explaining a sequence of a finger-contact sensing process, a display-orientation (portrait or landscape orientations) control process, and a display-size adjusting process when display data is a map;

FIGS. 17A to 17C are schematic diagrams for explaining a case where the display apparatus is operated by being held with both hands;

FIG. 18 is a flowchart of the process for change in layout of the display apparatus;

FIGS. 19A to 19C are schematic diagrams for explaining display control performed by a display apparatus according to a second embodiment of the present invention over a document in the vertical writing; and

FIGS. 20A to 20C are schematic diagrams for explaining another display control, performed by the display apparatus according to the second embodiment, for reducing a size of a document in the vertical writing.

### DETAILED DESCRIPTION OF THE PREFERRED EMBODIMENTS

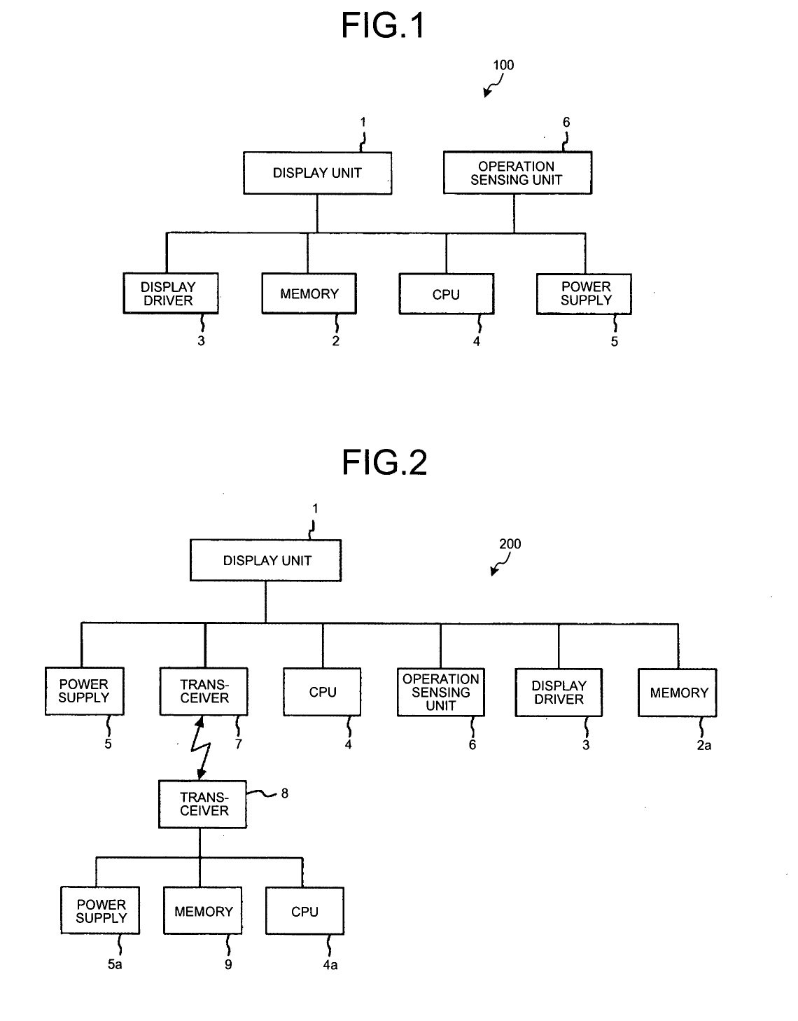

Exemplary embodiments of the present invention are explained in detail below with reference to the accompanying drawings. FIG. 1 is a block diagram of a display apparatus 100 according to a first embodiment of the present invention.

The display apparatus 100 includes a display unit 1, such as a liquid crystal display and an electronic paper device that is flexible and portable, and a display driver (display control unit) 3 that displays an image on the display unit 1, these of which are incorporable in the display apparatus 100.

The display unit 1 includes a memory 2, an operation sensing unit 6 that senses an instruction trough a finger operation or a position of a finger contact, a central processing unit (CPU) 4 that entirely controls operations, and a power supply 5 that supplies power required for the operations such as driving of the display unit 1. The memory 2 includes a read only memory (ROM) being a data storage unit (original-image bitmap-data storage unit) 10 and a display random access memory (RAM) 11. The original-image bitmap-data storage unit 10 stores therein documents and image data to be displayed on the display unit 1. The display RAM 11 temporarily stores therein the data to be displayed.

FIG. 2 is a block diagram of a display apparatus 200 according to a modification of the first embodiment. The display apparatus 200 includes a memory 9 that can store therein enormous amounts of page information as an external device separated from the display unit 1, and transceivers 7 and 8 that transmit and receive data to be displayed by using wireless communication (e.g., communication by using an infrared ray or bluetooth).

A memory 2a that temporarily stores therein data to be used for rewriting of the display is provided in the display unit 1. A CPU 4a that controls the memory 9 is additionally provided therein. A power supply 5a supplies power required for these operations.

With such a configuration, the display apparatus can prevent the size of a display unit, which is held by an operator who views a document displayed thereon, from being increased even if a large-capacity storage device such as a hard disk is used as the storage device that stores therein enormous amounts of page information to be displayed.

If the display apparatus 100 displays a full-color image, an information amount increases, which leads to an increase in size of the storage device, and thus a size of the display apparatus 100 increase. However, the display apparatus 200 allows avoidance of these problems.

In the modification as shown in FIG. 2, parts corresponding to those in the first embodiment as shown in FIG. 1 are denoted with the same reference numerals, and the same description is not repeated.

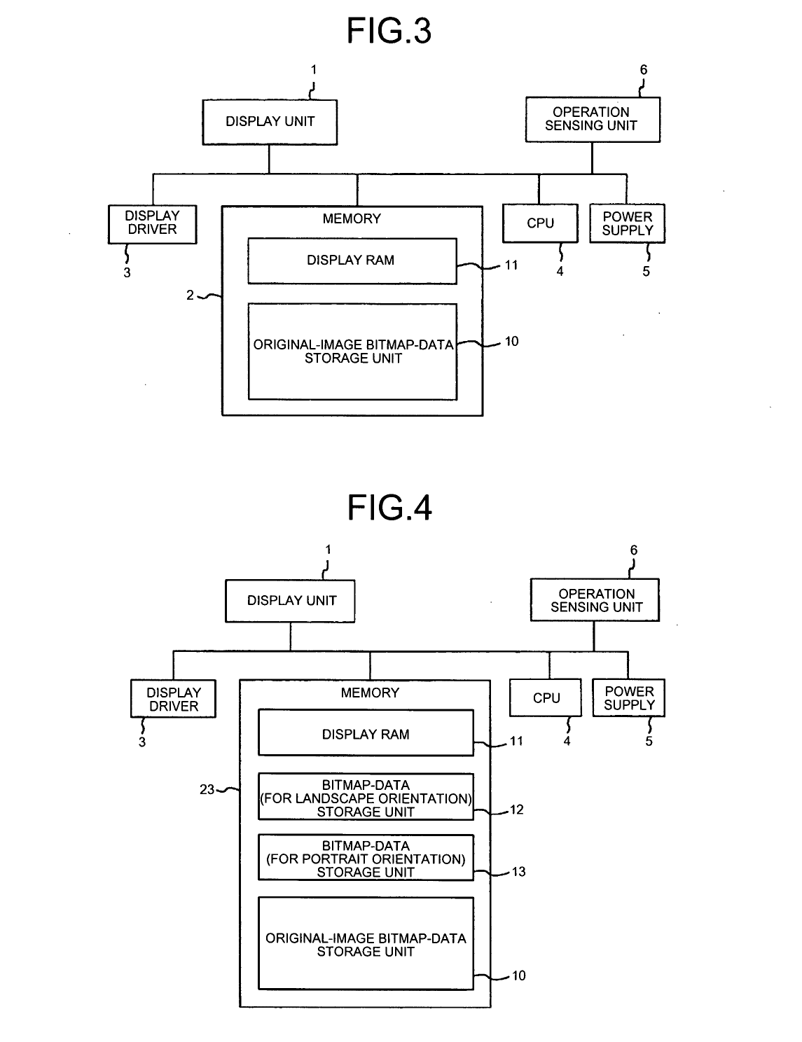

FIG. 3 is a block diagram of a first example of the memory 2. In the configuration of the first example, the memory 2 includes the original-image bitmap-data storage unit 10 that stores therein bitmap data for the document and image data to be displayed, and the display RAM 11 that temporarily stores therein the data to be displayed.

The original-image bitmap-data storage unit 10 and the display RAM 11 function independently from each other. Original data for the document and the image data to be displayed and coded data therefor can also be stored therein.

Part of or whole of the bitmap data stored in the original-image bitmap-data storage unit 10 is selectively written in the display RAM 11, and the display unit 1 reads and displays the bitmap data.

FIG. 4 is a block diagram of a memory 23 as a second example of the memory 2. In the configuration of the second example, the memory 23 includes a bitmap-data (for landscape orientation) storage unit 12 and a bitmap-data (for portrait orientation) storage unit 13, in addition to the original-image bitmap-data storage unit 10 and the display RAM 11 which are included in the memory 2.

The operation sensing unit 6 senses a position of a finger contact and an instruction through a finger operation, and orientation of an image to be displayed is determined from either a landscape orientation or a portrait orientation based on result of the sensing.

Next, either one of the bitmap-data (for landscape orientation) storage unit 12 and the bitmap-data (for portrait orientation) storage unit 13, in which the respective bitmap data for display is previously stored, is selected, and the stored bitmap data for display is written in the display RAM 11, and the display unit 1 reads and displays the bitmap data.

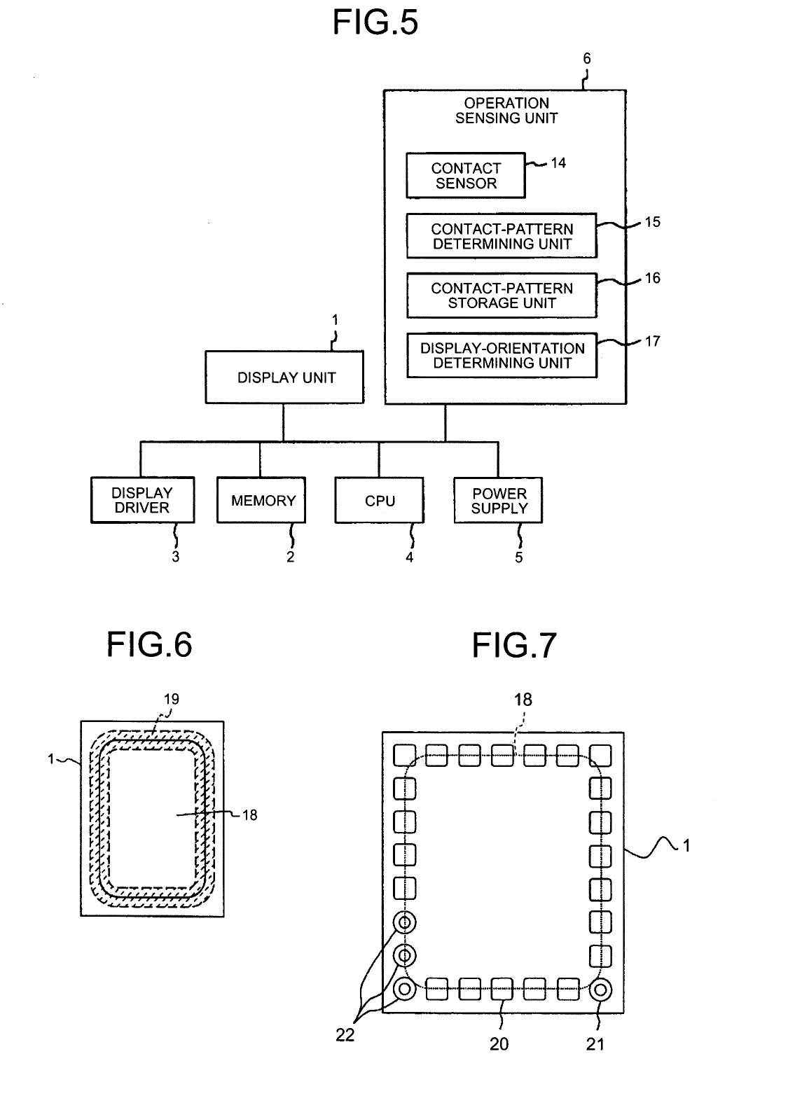

FIG. 5 is a block diagram of the operation sensing unit 6. FIG. 6 is a schematic diagram of a display area 18 of the display unit 1. FIG. 7 is a detailed schematic diagram of the display unit 1. As shown in FIG. 7, a plurality of touch sensors 20 is arranged along an outer periphery of the display unit 1. The touch sensors sense a position of a finger contact and an instruction by using a finger operation.

As shown in FIG. 6, the display unit 1 includes a display area 18 and a finger-contact sensing area 19.

As shown in FIG. 5, the operation sensing unit 6 includes a contact sensor 14, a contact-pattern determining unit 15, a contact-pattern storage unit 16, and a display-orientation determining unit 17. The contact sensor 14 automatically senses a position of a finger contact and a finger operation by the touch sensors 20.

The contact-pattern determining unit 15 determines whether the contact is valid or invalid. By arranging the touch sensors 20 along the outer periphery of the display unit 1, the touch sensors 20 form the contact sensor 14 that senses a finger contact in a wide range. While allowing various manners to be held, the display unit 1 includes a determining unit that determines validity of a contact thereby eliminating probability of an erroneous contact.

By providing the determining unit that determines whether the contact is a finger contact, an invalid contact is avoided. The contact-pattern determining unit 15 determines based on a determination principle whether the contact is a finger contact.

The determination principle include: (1) if a contact area is too large for a finger contact, determining that the contact is not the finger contact; and (2) if contact areas that are apart from each other are three or more, determining that the contact is not the finger contact.

The contact-pattern determining unit 15 identifies a finger area and a position of the finger. More specifically, when determining that a finger contact is valid, the contact-pattern determining unit 15 identifies a position of the finger contact. The display-orientation determining unit 17 determines a display orientation based on the finger contact position obtained by the contact-pattern determining unit 15. A method of determining the display orientation based on the finger contact position is as explained above.

The contact-pattern storage unit 16 stores patterns of finger contacts with respect to time. Based on the patterns stored in the contact-pattern storage unit 16, it is determined that the case, where the positions of the fingers are not changed much due to change of the manner of holding the device, is not detected as contact change.

In the display unit 1 as shown in FIG. 6, an area inside of a dotted line is the display area 18. The display driver 3 detects the display area 18, and writes data only within the display area 18.

A range of the display area 18 can also be automatically changed. It is also configured to detect an area held with fingers and enable to determine an area covered with the fingers as non-display area. The display on the area except for the area covered with the fingers allows the user to read it more easily.

The hatched area in FIG. 6 is the finger-contact sensing area 19 where a finger contact position can be sensed. The finger-contact sensing area 19 is provided along an outer periphery of the display unit 1.

As explained above, an area on the display unit 1 where contact positions of fingers can be sensed is limited. If the finger contact is sensed all the edge portions of the display unit 1, it is quite possible that the operation is erroneous. Hence, by limiting the range of a finger-contact detectable area, it is possible to prevent a contact from being erroneously operated during the finger operation of the display unit 1.

When a finger contacts with the finger-contact sensing area 19, the operation sensing unit 6 senses a position of the finger contact or receives an instruction by using the finger operation. Typically, as shown in FIG. 7, the position and the instruction are sensed by using the touch sensors 20 that are arranged along the outer periphery of the display unit 1. A configuration of the display unit 1 shown in FIG. 7 is one of examples.

When a user touches one of the touch sensors 20, the display unit 1 senses a contact position, and displays a result of sensing on the display area 18. The touch sensors 20 can be a touch sensor array including touch sensors each of which has a block shape with an about 10 millimeters square.

A size of the block is not necessarily limited to the 10 millimeters square. As the block size is smaller, a shape of a finger contact can be caught more accurately. As the block size is larger, an entire configuration can be more simplified. The block size can be defined as appropriately.

A pressure sensor, a weight sensor, and an optical sensor can be used instead of the touch sensors 20. If an object to be placed on a tray has heat, then a temperature sensor or an infrared sensor can also be used. In addition to the touch sensors 20, the display unit 1 includes a power switch 21 to activate the power supply 5 that supplies power required for these operations.

As shown in FIG. 3 or 4, the display RAM 11 is mounted on the memory 2 or 23, and the display driver 3 is incorporated in the display apparatus 100. The display driver 3 can be stored in another ROM (not shown) and loaded on another RAM (not shown) to be implemented. The display driver 3 is controlled by the CPU 4.

The display area 18 is made of a plurality of dots, arranged in a matrix, each of which is a pixel indicating different brightness depending on translucent light and non-translucent light.

The bitmap data of an original image to be displayed is stored in the original-image bitmap-data storage unit 10. A part or all of the bitmap data is written in the display RAM 11, and is displayed by bit in the display area 18 by the display driver 3.

After a write range is specified in the original image data, the bitmap data for the specified data is written in the display RAM 11 by changing a write start address of the display RAM 11 and the order of writing (writing direction), to thereby change the content of display.

As shown in FIG. 7, operation buttons 22 are incorporated in the display unit 1. Various instructions can be issued by pressing a corresponding button. The operation buttons 22 can include a button for issuing an instruction to read image data.

As explained above, the display unit 1 includes not only the touch sensors 20 along the outer periphery, which allows the display unit 1 to be held in various manners, but also the contact-pattern determining unit 15 (FIG. 5) that determines a contact pattern. As a result, the display unit 1 allows various manners to be held, while preventing an erroneous estimation about a contact.

In other words, in the display apparatus according to the present embodiment that estimates a finger position (or a manner to be held) and performs an image display control (including display-orientation adjusting process and a layout adjusting process), the touch sensors 20 helps in increasing accuracy of estimation concerning the finger position.

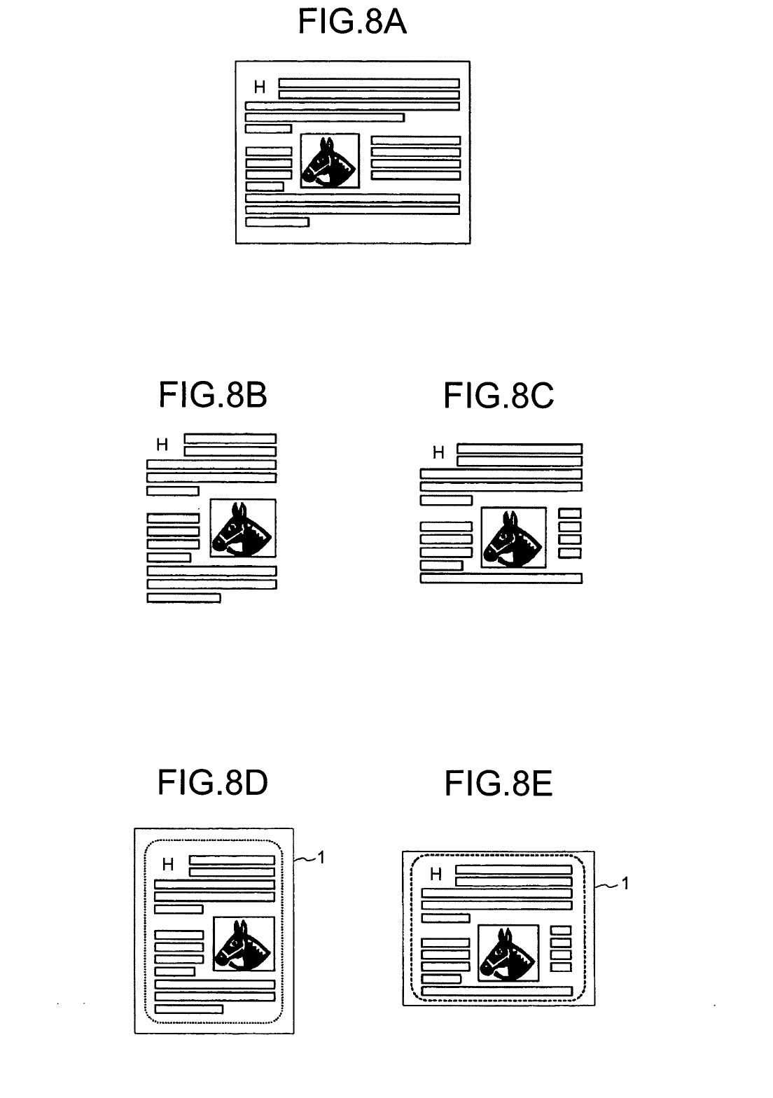

FIGS. 8A to 8E are conceptual schematic diagrams for explaining the display control performed by the display apparatus 100. FIG. 8A represents bitmap data for the original image stored in the memory 2.

The following operations are performed from the above state in such a manner that a write range is set based on the instruction of the operation sensing unit 6 (FIG. 5) and the bitmap data is written in the display RAM 11, and that the written bitmap data as shown in FIGS. 8B and 8C is written out in the display unit 1 by the display driver 3, and is displayed on the display unit 1 as shown in FIGS. 8D and 8E.

Each address of the display RAM 11 and each display position in the display area of the display unit 1 are in one-to-one correspondence with each other, and thus, by changing the direction of writing in the display RAM 11, the display orientation of the display area can easily be changed.

For example, bitmap data is written in the display RAM 11 so that the upper left of the bitmap data for the original image is caused to correspond to the lower right of the display RAM 11 and the lower right of the bitmap data is caused to correspond to the upper left of the display RAM 11. By doing so, the bitmap data can be displayed in upside-down orientation to the arrangement of the bitmap data for the original image.

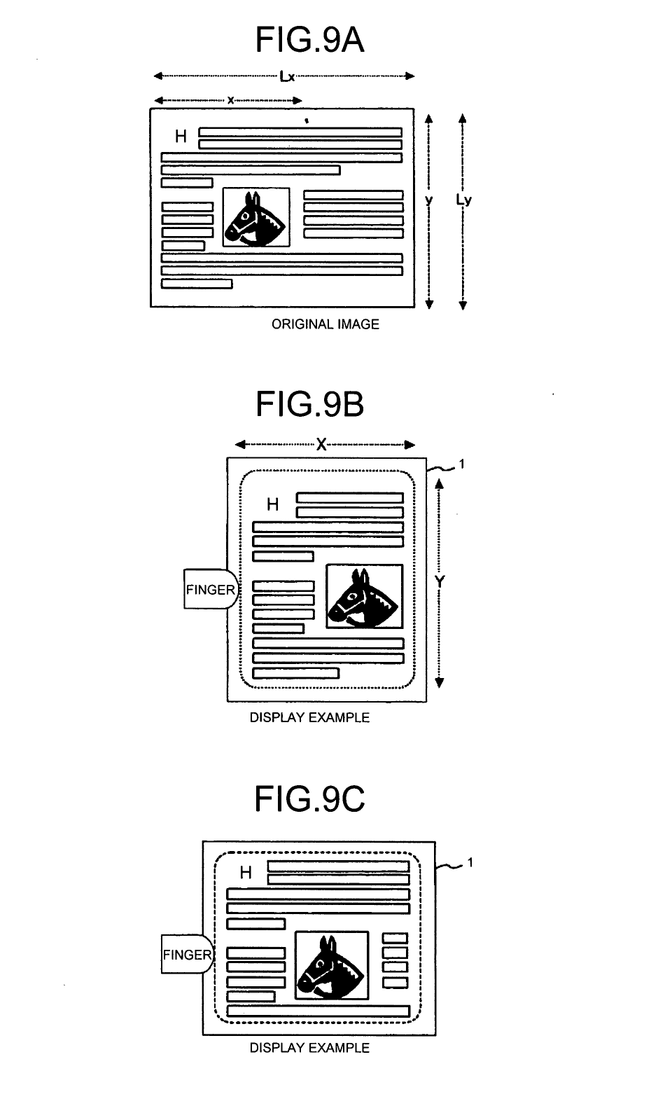

FIGS. 9A to 9C are schematic diagrams for explaining display control performed by the display unit 1 based on result of sensing in the finger-contact sensing area 19. The control for the display orientation (portrait or landscape orientation) using the finger contact position is explained below. The display apparatus 100 is assumed to be a portable one that a user can easily hold by hand.

The display apparatus 100 typically refers to an electronic paper device capable of being freely and easily handled like paper. The display unit 1 has a thin-film display structure in which the display layer and the thin film layer for controlling the display layer are integrated into one unit. A method of displaying the display layer includes a microcapsule electrophoresis and a twist ball method.

The display unit 1 has a function of controlling the display orientation (portrait or landscape orientation) based on a finger contact position. FIG. 9A represents the original image, and this image indicates a typical document image of arbitrary size. The image can be data with only text or can be a picture image.

FIGS. 9B and 9C are schematic diagrams each in which the portrait or landscape orientation of the original image is changed based on a position of a finger in contact with the display unit 1 (position of holding it by hand). More specifically, when the display unit 1 is held in its portrait orientation (FIG. 9B), then it is displayed in the portrait orientation, while when it is held in its landscape orientation (FIG. 9C), then it is displayed in the landscape orientation.

In this example, because the size of the original image is an arbitrary size, not all the image can be displayed. However, the size can be automatically scaled down or the layout may be automatically changed, to thereby change the display so that the image can be easily read.

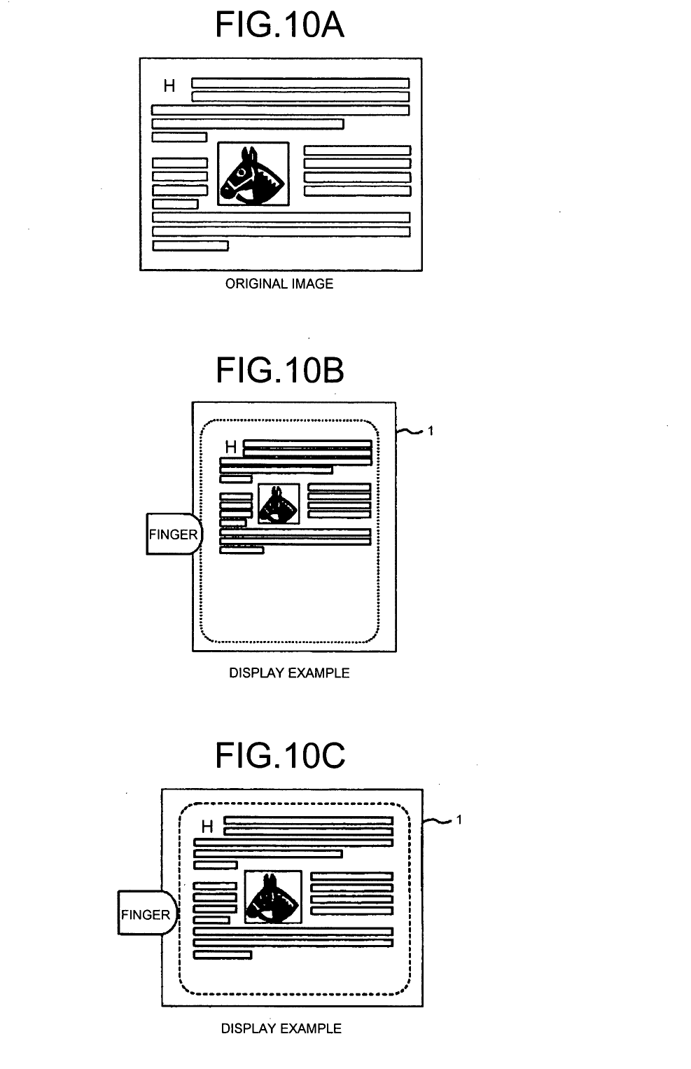

FIGS. 10A to 10C are schematic diagrams for explaining another display control performed by the display unit based on result of sensing in the finger-contact sensing area 19. FIG. 10A represents the original image, and this image indicates a typical document image of arbitrary size. The image can be data with only text or may be a picture image.

FIGS. 10B and 10B are schematic diagrams each in which the portrait or landscape orientation of the original image is changed based on a finger position on the display unit 1 being the display apparatus (position of holding it by hand).

In FIGS. 10A to 10C, to resolve the problem that not all the image can be displayed because the size of the original image is an arbitrary size, the size can be automatically scaled down or the layout can be automatically changed, to thereby change the display so that the image can be easily read. More specifically, when the display unit 1 is held in its portrait orientation, then it is displayed in the portrait orientation (FIG. 10B), while when it is held in its landscape orientation, then it is displayed in the landscape orientation (FIG. 10C).

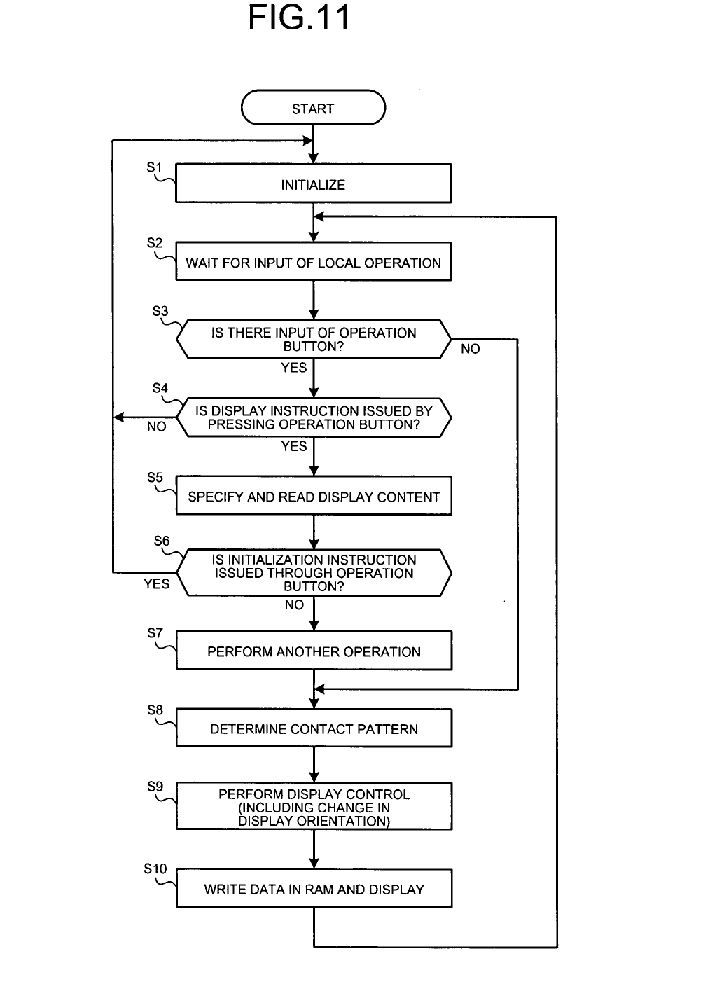

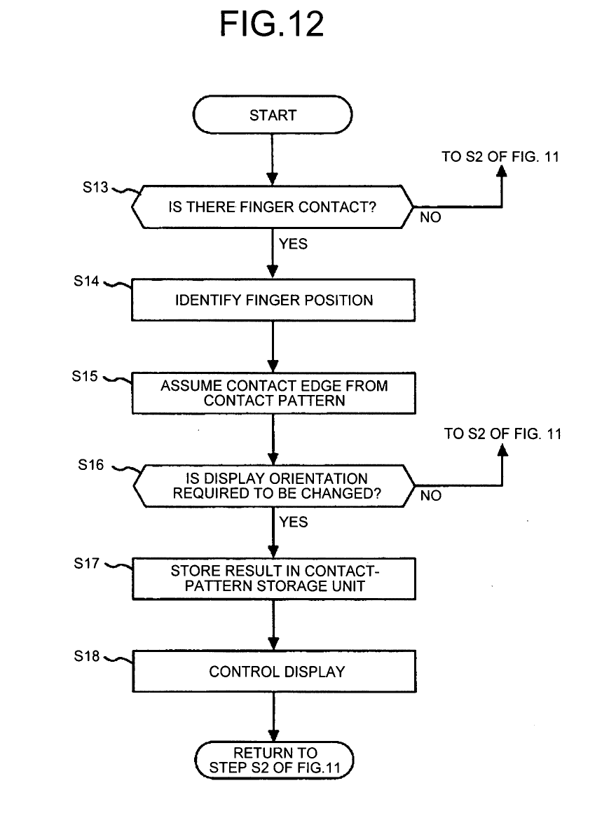

FIG. 11 is a flowchart of the process of controlling the display orientation (vertical or horizontal display orientation) based on the finger contact position performed by the display apparatus 100. When a finger contact is sensed and any change is sensed in the edge which the finger contacts, the display orientation (portrait or landscape orientation) is changed.

At first, initialization is performed (step S1). More particularly, the power switch 21 (FIG. 7) of the display unit 1 is turned on and then the whole apparatus is started by the power supply 5 shown in FIGS. 1 to 4.

Next, in the basic operation control, an input of a local operation is waited (step S2), and it is determined whether there is an input of the operation button (step S3). If there is an input of the operation button (Yes at step S3), then it is further determined whether a display instruction is issued by pressing the operation button (step S4). If the display instruction is to be issued (Yes at step S4), a display content is specified and the specified content is read (step S5).

It is then determined whether an instruction is an initialization instruction issued through the operation button 22 (step S6). If it is not the initialization instruction (No at step S6), then an operation corresponding to the instruction is performed (step S7), and a contact pattern is determined (step S8).

The display control (including the change in the display orientation) is performed if necessary (step S9). Thereafter, the display orientation is determined, a range of the bitmap data stored in the original-image bitmap-data storage unit 10 is selected, and the selected range is written in the display RAM 11 and is displayed (step S10). After step S12, the process control returns to step S2 and waits until receiving a local operation. If it is determined that there is no input through the operation button (No at step S3), then the process control goes to step S8. When the initialization instruction is issued through the operation button 22 (Yes at step S6), the process control returns to step S1, where initialization is performed.

The operation buttons 22 include a button for a display instruction to read and display image data. Therefore, the display unit 1 identifies an instruction of an operation button 22 and executes an operation instruction corresponding to the operation button 22. The operation buttons 22 can include a button for an initialization instruction to initialize the whole, an operation instruction to delete the display, or an operation instruction to change the display resolution.

If the display instruction is input, the image data is loaded into the memory 2 of FIGS. 1 to 4, and bitmap data matching the display resolution is generated, to store the generated data in the original-image bitmap-data storage unit 10 on the memory 2.

As explained above, it is allowable to specify each of display areas for landscape-orientation data and for portrait-orientation data, and store bitmap data for the horizontal or the portrait orientation in either the bitmap-data (for landscape orientation) storage unit 12 or the bitmap-data (for portrait orientation) storage unit 13.

Referring to the control for display based on the finger operation, the contact pattern is determined (step S8), and the display control is performed (including the change in the display orientation) if necessary (step S9). As explained above, the display orientation is determined, a range of the bitmap data stored in the original-image bitmap-data storage unit 10 is selected, and the selected range is written in the display RAM 11 and is displayed (step S10). Thereafter, the process control returns to step 2 waits until receiving a local operation. The display range is determined by specifying a displayable range with respect to the size of the display unit 1.

In this manner, the display is controlled based on a contact pattern including a position and a sequence of the finger contact. The contact pattern concerning the finger contact position includes not only information for each positional relationship in finger contacts but also history of the finger contacts.

The state of an image that is displayed on the display unit 1, which can be freely and easily handled, is automatically adjusted according to the manner of holding it. However, there are various manners of holding it, and thus, it is not always the same as the supposed finger contact. Therefore, if the manner of holding it is to be automatically estimated, it is important to improve the accuracy of estimation of user's intention.

As shown in FIG. 7, the display unit 1 includes the touch sensors 20 along the outer periphery, which allows the display unit 1 to be held freely. Furthermore, the contact-pattern determining unit 15 that determines a finger contact pattern is provided to control the display so that that display matches each of the various manners of holding it while an erroneous estimation is prevented.

It is possible to be configured to estimate a finger position (how to hold it) and to control the display (control process for display orientation or layout display) based on the estimation result.

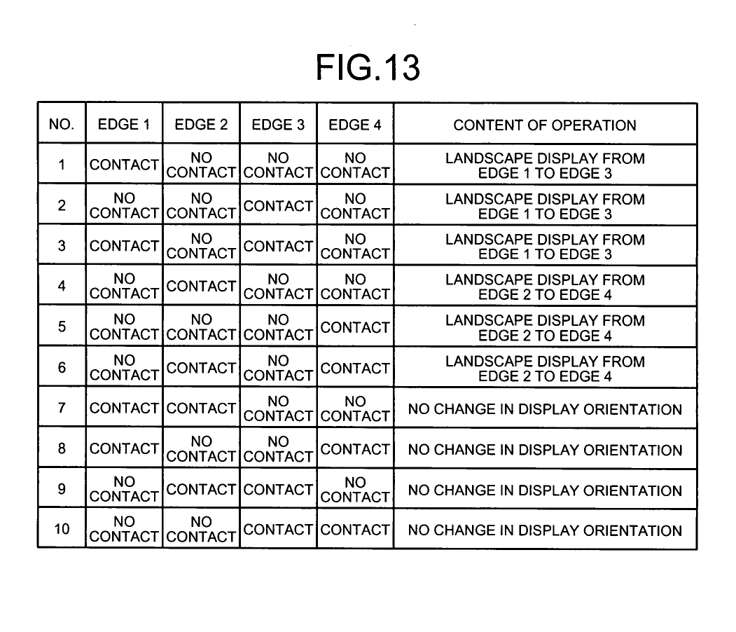

FIG. 12 is a flowchart of the display control process performed by the display apparatus 100 based on a finger operation. FIG. 13 is a contact-pattern table including a finger contact pattern, a contact edge, and the content of operation. The finger contact pattern is determined as follows.

Referring to FIGS. 11 and 12, the finger-operation based display control process is explained. It is sensed whether there is a finger contact (step S13). If there is no finger contact (No at step S13), then the process control goes to step S2 in FIG. 11. If there is a finger contact (Yes at step S13), then the finger position is identified (step S14).

Next, an edge contacting with the finger is assumed from the contact pattern (step S15). It is then determined whether the display orientation is required to be changed (step S16). When the display orientation is not required to be changed (No at step S16), then the process control goes to step S2 in FIG. 11. When the display orientation is required to be changed (Yes at step S16), then the result is stored in the contact-pattern storage unit 16 (step S17), and the display control (including the change in the display orientation) is performed (step S18), and goes to step S2 of FIG. 11.

Furthermore, a finger contact is first sensed. When the contact is sensed, the finger position is identified, and a contact pattern is determined. By checking contact signals of the touch sensors 20, the positions where the contact signals are detected are regarded as positions where the finger contacts probably occur.

Continuous contact areas are determined as one contact area. The area of the continuously provided touch sensors 20 is limited, as the area of fingers, to a location where the fingers contact a continuous area including one to three touch sensors 20. It is then estimated which of the four edges of the display unit 1 the fingers contact.

Firstly, when there is a contact at one of the edges, it is estimated that there is a finger contact at this edge. Secondly, when there are contacts at two edges and the two edges face each other, the contacts are estimated at the two edges. Thirdly, when there are contacts at two edges but the two edges do not face each other, then the estimation is regarded as erroneous one, and the temporal change of the recorded finger contact patterns is checked to estimate that the contact at the previous edge may be continued.

Fourthly, when there are contacts at three different edges, it is estimated that these edges are contact edges which face each other. Fifthly, when there are contacts at all the four edges, the estimation is regarded as erroneous one, and the temporal change of the recorded finger contact patterns is checked to estimate that the contact at the previous edge may be continued.

Subsequently, the temporal change of the recorded finger contact patterns is checked, and if the estimated contact edge is different from the previous one, then the difference is recorded in the contact-pattern storage unit 16 (FIG. 5), to control the display orientation. If the change does not refer to the change in the contact edges facing each other, the display orientation is changed.

It is estimated which part of the four edges of the display unit 1 is held, and as explained above, data is displayed in a display orientation so that the edge being held becomes the horizontal orientation and different edges therefrom become the vertical orientation.

There is sometime a case where the display becomes upside down in its vertical orientation. However, it is assumed that the display unit 1 is held by the user's left hand, and it is therefore displayed so as to cause the left side of the display to be shifted to the left hand. It is obvious that if the manner of holding it is changed, the reverse of the vertical orientation can easily be released. Moreover, the accuracy of estimation of the display orientation may be improved using a gravity sensor.

As explained above, the display-orientation determining unit 17 (FIG. 5) determines the finger contact pattern recorded in the contact-pattern storage unit 16 and controls the display orientation. In this case, a table for use in determination is prepared, and the pattern can also be determined using the previously registered table.

Described in a contact-pattern table, as shown in FIG. 13, are a contact pattern in the left side thereof and an instruction content of display operation in the right side thereof when such a pattern contact is detected. As the contact pattern, each contact edge is described, and each content of corresponding display process is described.

FIG. 13 represents 10 contact patterns. In Nos. 1 to 6 patterns, the display orientation is changed. In Nos. 7 to 10 patterns, the display orientation is not changed. Any other contact patterns are regarded as erroneous recognition, and the display is therefore controlled so as not to change the display orientation.

The contact-pattern table as shown in FIG. 13 is an example, and the process content can be changed depending on how to use it. The content may be any instruction other than the control for the display orientation.

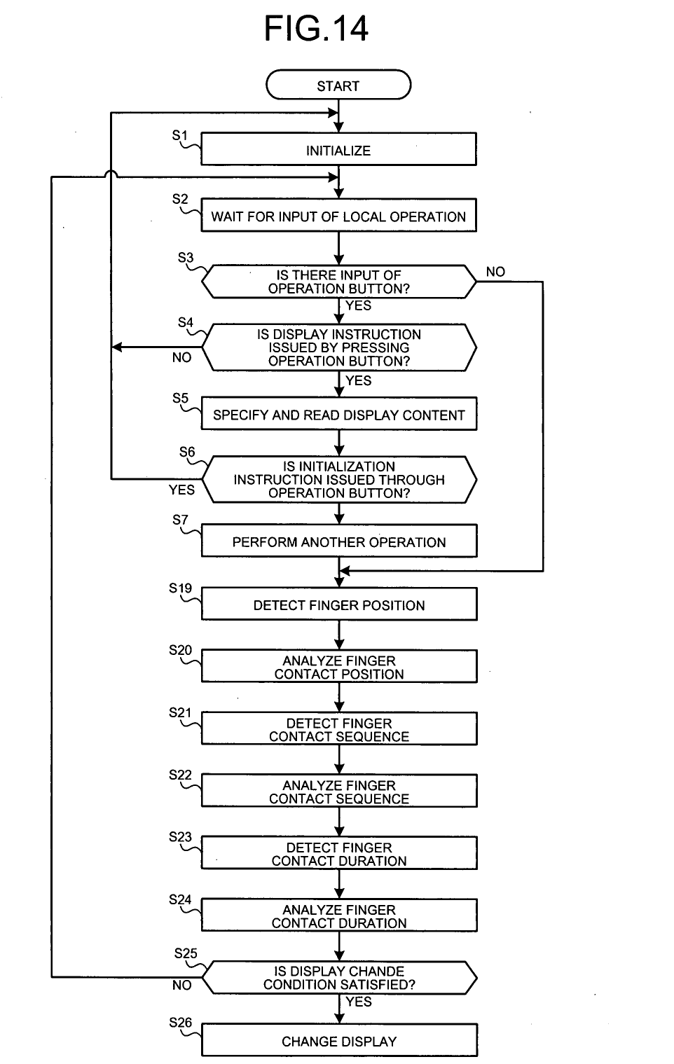

FIG. 14 is a flowchart of the display control process performed by the display apparatus 100 based on a finger contact sequence or a contact time. The display apparatus 100 includes the contact-pattern determining unit 15 of FIG. 5 that determines a finger contact pattern and identifies a finger position (how to hold it), which allows the display control (control process concerning display orientation or layout display) so as to match each of various manners of holding it while erroneous estimation of user's intention is prevented.

There are a variety of manners of holding the electronic paper device such as the case of being held with not one hand but with both hands, the sequence of touching the edges, and the time for holding it. It is therefore desired to control the display corresponding to any one of these variations such as finger contact sequence and contact time.

When the display is controlled based on the finger operation, the display can also be controlled not only by a finger position (finger contact position) but also by a finger contact sequence or a finger contact duration. The display control includes the control for the portrait or landscape orientation. However, the control for the display orientation (portrait or landscape orientation) can be performed together with the change (scaling) of layout.

The sequence of finger contacts can be obtained by sequentially recording positions of the contact when the finger contact is sensed. The display can also be controlled by the finger-contact sequence. For example, if two fingers contact with the device unit 1, the display orientation (portrait or landscape orientation) is controlled by first contacts with the two fingers, the image is reduced by next contacts and the reduced image is displayed, and the image is further reduced by the following contacts and the further reduced image is displayed.

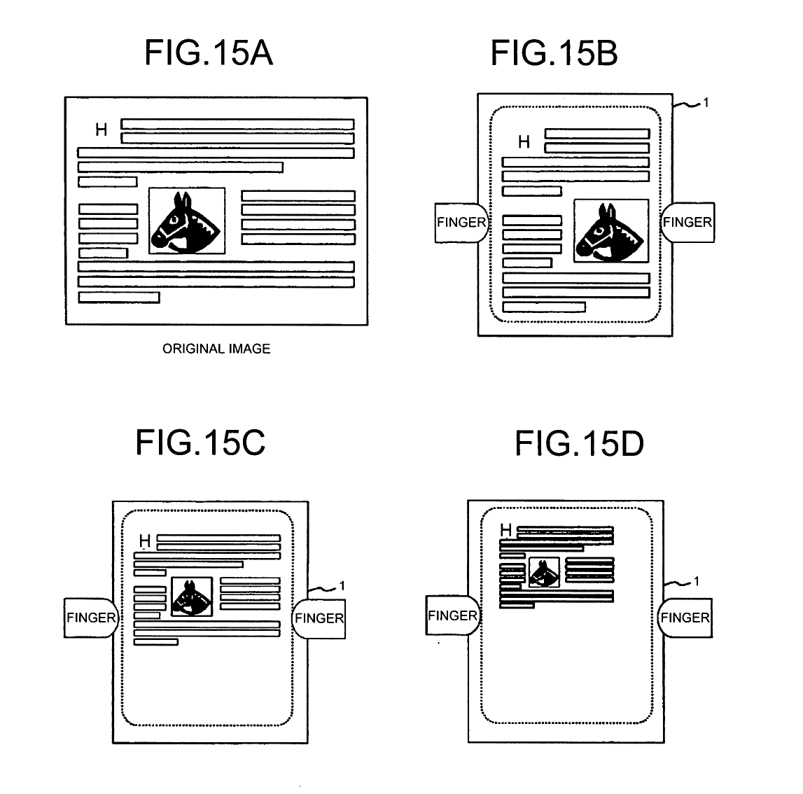

FIGS. 15A to 15D are schematic diagrams for explaining a sequence of a finger-contact sensing process, a display-orientation (portrait or landscape orientations) control process, and a display-size adjusting process. By controlling the display corresponding to a detected sequence of finger contacts, the display range can be freely adjusted.

When the display orientation is changed, the original image shown in FIG. 15A usually has some parts of the original image which cannot be displayed as shown in FIG. 15B. Therefore, it is effective to increase the display range by reducing the original image as shown in FIG. 15C.

Similarly, duration of a finger contact can be obtained by sequentially recording the contact position and the contact time at which the finger-contact is detected. The duration of the finger contact is an elapsed time during which the contact is continuous or an elapsed time during which there is no contact. More specifically, a contact is checked at each time interval, and a start time of the contact (time at which a finger not in contact with the device actually contacts it) and an end time thereof (time at which the finger separates from the device) are recorded, and the contact duration can thereby be detected.

In this case, the display unit 1 further includes a timer (not shown) and refers to the timer when the contact is sensed. The display can be controlled by the finger contact sequence and the finger contact duration.

Furthermore, all the finger position (finger contact position), the finger contact sequence, and the finger contact duration are detected, and the contact pattern can be displayed as the finger position (finger contact position) and the finger contact duration, or as the finger position (finger contact position), the finger contact sequence, and the finger contact duration.

When two fingers contact the device in the example of FIGS. 15A to 15D, the display orientation (portrait or landscape orientation) is controlled by first contacts with the two fingers. If the elapsed time since then is within a predetermined time or next contacts are detected within a predetermined time, the image is reduced by the next contacts, and the reduced image is displayed (FIG. 15C).

If the elapsed time since then is within a predetermined time, the image is further reduced by the following contacts, and the further reduced image is displayed (FIG. 15D). Furthermore, if the elapsed time during which there is no contact is long, the display (display in the magnification set by default) is returned to that in the original magnification.

Explanation is given with reference to the flowchart of FIG. 14. Steps 1 to 7 are performed in a manner similar to steps 1 to 7 shown in FIG. 11. Explanation for those steps is not repeated.

In the finger-operation based display control, a finger position is detected (step S19), a finger contact position is analyzed (step S20), a finger contact sequence is detected (step S21), the finger contact sequence is analyzed (step S22), a finger contact duration is detected (step S23), and the finger contact duration is analyzed (step S24). Next, it is determined whether a display change condition is satisfied (step S25). If the display change condition is satisfied, then the display is changed (step S26). If the display change condition is not satisfied, then the process control goes to step S2.

In the finger-operation based display control, the contact-pattern determining unit 15 of FIG. 5 that determines a finger contact pattern is provided, and the history of changes of the finger contacts is stored in the contact-pattern storage unit 16. And the contact-pattern determining unit 15 determines not only the finger contact position but also the finger contact sequence and the finger contact duration.

For example, the sequence of finger contacts is analyzed to detect the lateral change of the contact positions from one side to the other upon change of the manner of holding it and then detect the change in the orientation of the electronic paper device, and the display orientation is changed to the other.

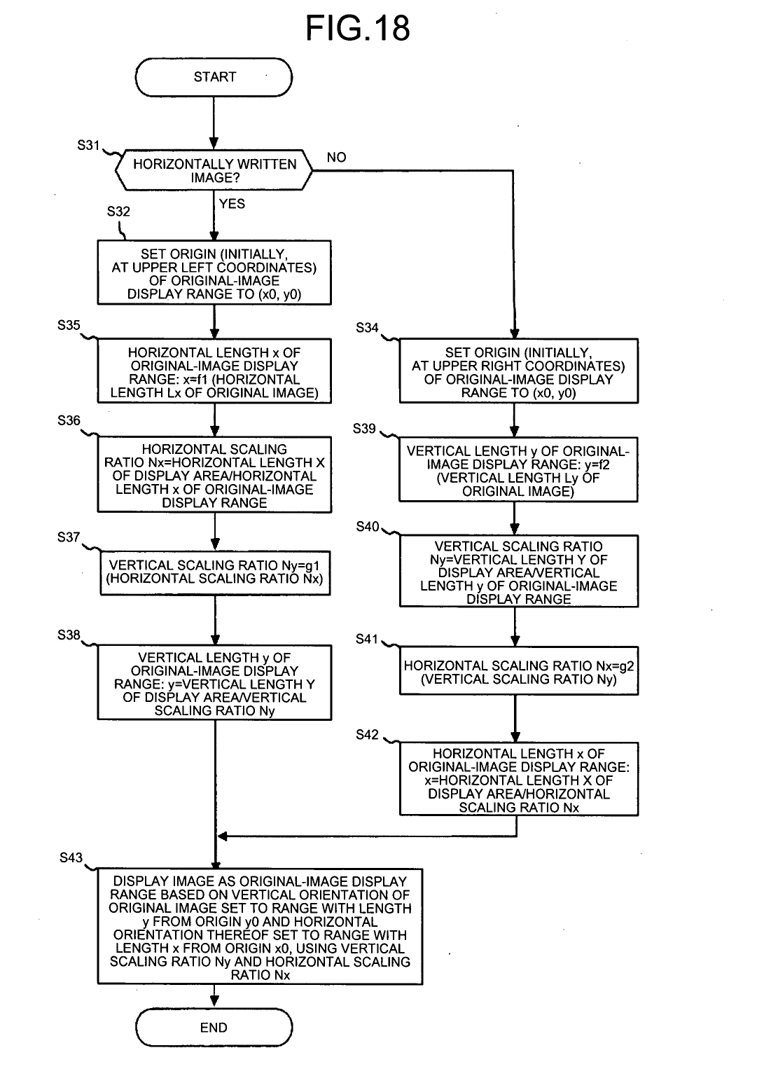

Furthermore, by also detecting the finger contact duration, it is determined that the time during which there is no finger contact has passed a predetermined time or more, for example, 10 minutes or more based on a display change condition at step S42 of FIG. 18 explained below, and corresponding display control can also be performed if necessary.

The display control as follows can easily be implemented. The display control is such that the display is stopped, the display is returned to default, or the state is entered into an energy saving operation in such a manner that the power is automatically turned off.

In the embodiments, although the explanation is limited to the case of display in the portrait or landscape orientation, a function of displaying data in an oblique orientation can be provided. Because the electronic paper device controls the display by pixels, the display in the oblique orientation becomes possible. For example, if the operation sensing unit 6 (FIG. 5) detects that two fingers obliquely contact the device, then the display is simply changed to the oblique orientation.

If the display unit 1 is configured to display on both surfaces thereof, the display can also be switched between the front and back surfaces. The display unit capable of displaying on both surfaces can be implemented by preparing, for example, two pieces of the electronic paper device capable of displaying on a single surface as shown in FIG. 7 and superimposing both devices on each other so that both screens thereof become mutually front surfaces.

In this case, the contact sensor is provided on the both surfaces. By detecting the orientation of the device using the finger position in the above manner, the display orientation is controlled, and finger contact areas on the front side and the back side are checked. If one side has a plurality of finger contacts on its wide area, then it is determined as the back side, and if the other side has a finger contact (contacts) on its narrow area, then it is determined as the front side. Thus, the display is controlled so as to be displayed on the front side.

The contact areas are compared with each other by comparing the numbers of the touch sensors 20 which each finger contacts, and it is determined that the larger number thereof indicates larger contact area. Moreover, the display is not performed on the screen on the back side obtained through identification, and thus, energy saving can be achieved.

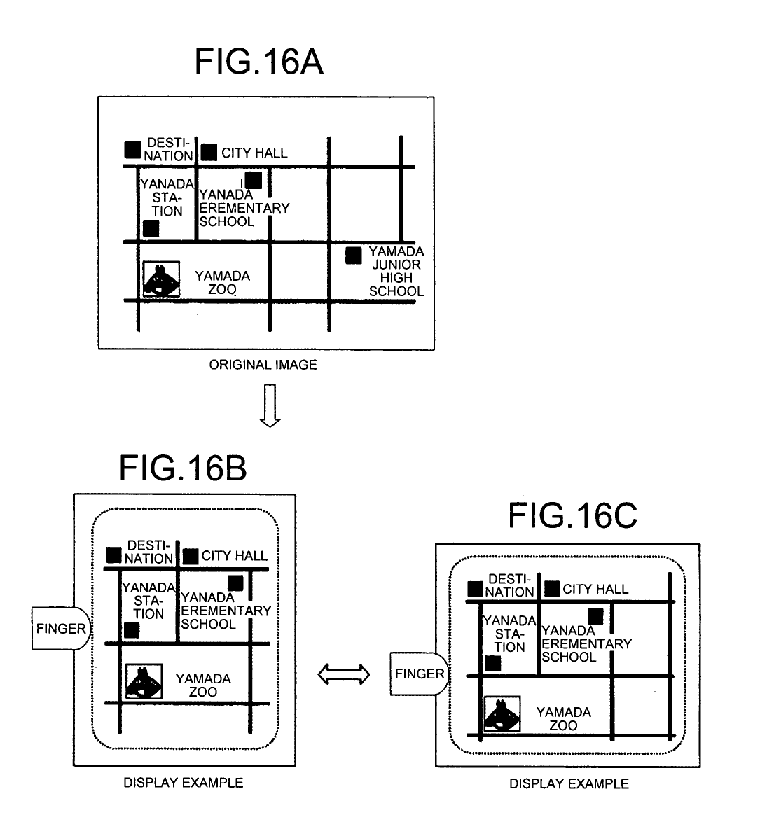

FIGS. 16A to 16C are schematic diagrams for explaining a sequence of a finger-contact sensing process, a display-orientation (portrait or landscape orientations) control process, and a display-size adjusting process when display data is a map. Even if the display data is the map, the display range can easily be changed, and thus, this case is indicated as one of effective examples.

The display is controlled according to the detected sequence of finger contacts, and the display range can thereby be freely adjusted. When the display orientation is generally changed, an instruction as follows can be easily provided. The instruction indicates whether the original image in FIG. 16A is changed so as to be displayed in the portrait orientation as shown in FIG. 16B or in the landscape orientation as shown in FIG. 16C.

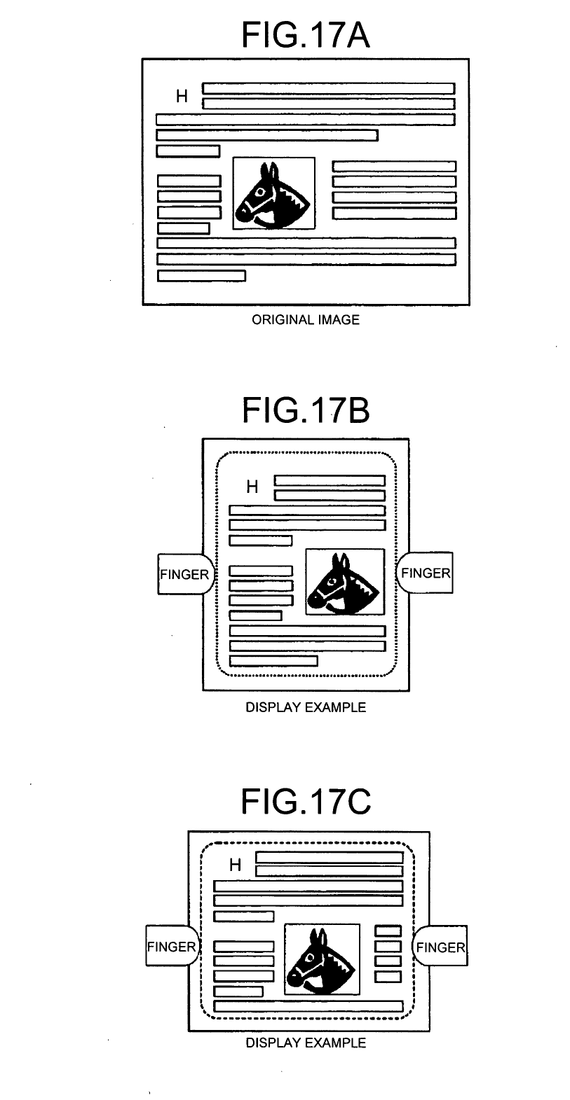

FIGS. 17A to 17C are schematic diagrams for explaining a case where the display apparatus 100 is operated by being held with both hands. Although the case where it is held with one hand is mainly explained, the case where it is held with both hands can also be implemented, as shown in FIGS. 17B and 17C.

The display is changed upon detection of contacts of two fingers with the display apparatus 100. There is sometimes a case where the user once holds the display unit 1 with one hand and then changes the manner of holding it so as to be firmly held. Thus, the orientation at which the display unit 1 is held can be reliably detected.

The display apparatus 100 includes a sensor that detects contact positions of two fingers on the electronic paper device and a display controller that displays according to the detection result. Based on this configuration, because there is sometimes the case as explained above, the operation with two fingers can more reliably be instructed as compared with the operation with one finger

Using two fingers enables the user to provide complicated instructions. For example, if an instruction is the change of layout, then the instruction whether the change is performed together with the control for the display orientation (portrait or landscape orientations) can easily be provided.

FIG. 18 is a flowchart of the process for change in layout of the display apparatus. The control for display orientation (portrait or landscape orientation) and the control for layout are explained below with reference to FIG. 18.

In the embodiment, a finger contact position is detected to thereby detect the change of the manner of holding the device, and the display layout (scaling) is changed simultaneously upon detection of the display orientation (portrait or landscape orientation).

The display controller is provided to select the portrait or landscape orientation based on the detected finger contact position on the display unit and to display changed display layout. Therefore, if the layout is displayed in the vertical or horizontal orientation as it is, then not all the data is displayed in some cases. Hence, by changing the display layout having been subjected to be scaled down (reduced), it is possible to read a wider range thereof.

In this process flow, the display orientation (portrait or landscape orientation) of the original image is not only changed but also scaled to be displayed, to achieve the change in layout display. Each length described in the flow represents each length in FIGS. 9A and 9B. That is, the length in the horizontal orientation of the original image is Lx, and the length in the vertical orientation thereof is Ly.

In FIGS. 9A and 9B, x represents the length in the horizontal orientation of the display range of the original image, and y represents the length in the vertical orientation thereof. When displayed, Nx represents a scaling ratio in the horizontal orientation and Ny represents a scaling ratio in the vertical orientation, and X represents a length in the horizontal orientation of the display area and Y represents a length in the vertical orientation thereof.

In the process flow, if it is a horizontally written image, by scaling the image so that all the image in the horizontal orientation is displayed, the whole of the initial portion of the original image content can be displayed, while if it is a vertically written image, by scaling the image so that all the image in the vertical orientation is displayed, the whole of the initial portion thereof can be displayed. The process flow indicates that the control for the display orientation is different between the horizontal writing and the vertical writing.

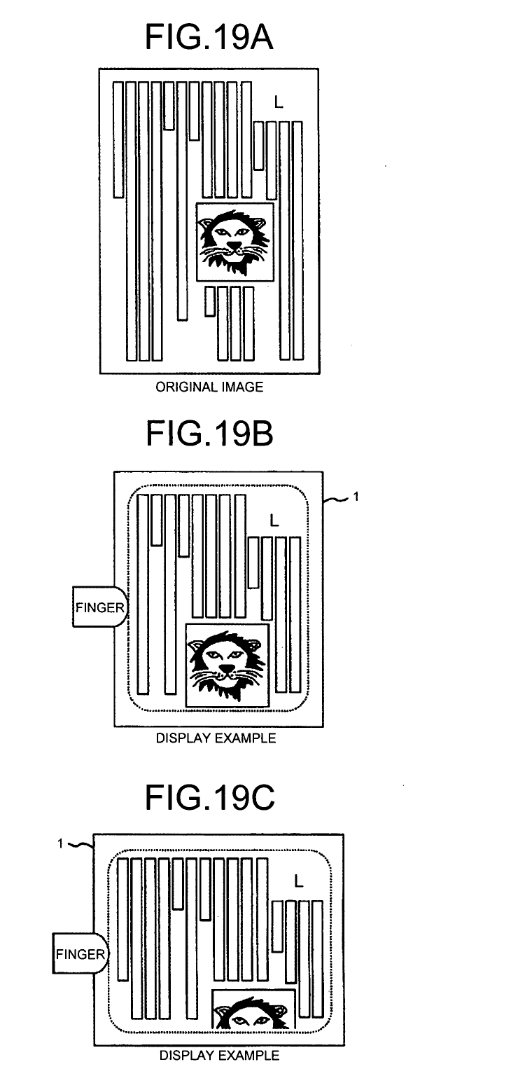

FIGS. 19A to 19C are schematic diagrams for explaining display control performed by a display apparatus according to a second embodiment of the present invention over a document in the vertical writing. FIG. 19A represents a vertically written original image, and the original image represents a typical document image of an arbitrary size.

FIGS. 19B and 19C are schematic diagrams each in which the display orientation is changed. More specifically, FIG. 9B represents the portrait orientation of the image and FIG. 9C represents the landscape orientation thereof based on each finger position (position held with the hand) on the display medium.

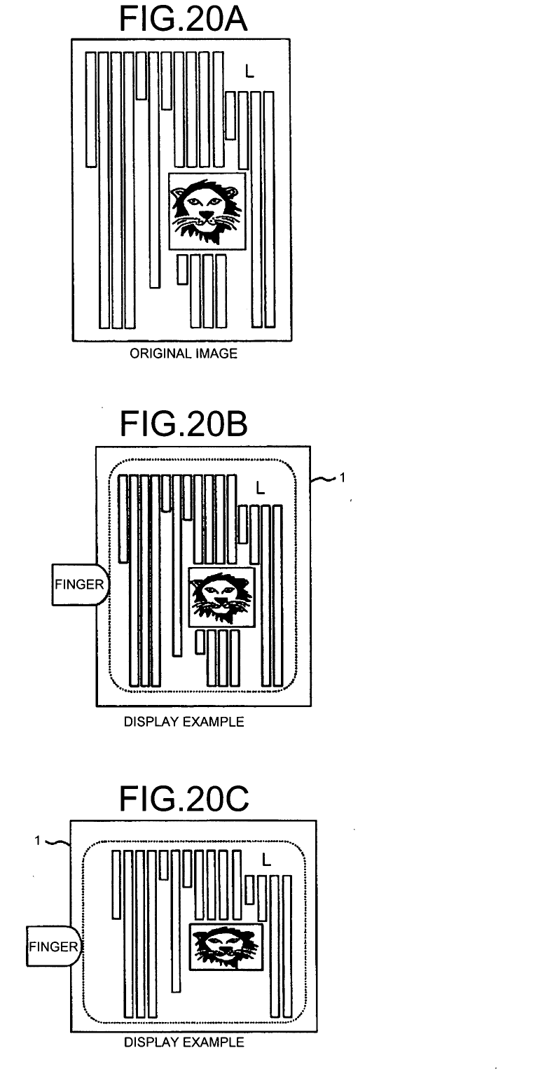

FIGS. 20A to 20C are schematic diagrams for explaining another display control, performed by the display apparatus according to the second embodiment, for reducing a size of a document in the vertical writing. FIGS. 20A to 20C represent an example in which the original image is automatically scaled down (reduced) on the display unit 1 or the layout of the original image is automatically changed thereon, to change the display so as to be easily read.

On the other hand, the schematics of the display control in the horizontal orientation are shown in FIGS. 9A to 9C as explained above, and the example, in which the original image is automatically scaled down (reduced) or the layout of the original image is automatically changed so that the display is easily read, is shown in FIGS. 10A to 10C. In the case of the vertical writing, the display control is provided from the upper right to the lower left, while in the case of the horizontal writing, the display control is provided from the upper left to the lower right.

Referring to FIG. 18, the layout change is explained. It is determined whether an image type is horizontally written (step S31). If it is a horizontally written image in which it is described from the upper left to the lower right (Yes at step S31), an origin (initially, at upper left coordinates) of the original-image display range is set to (x0, y0) (step S32).

Next, the process is shifted to the layout change of the horizontally written image, where it is determined whether the horizontal length x of the original-image display range: x=f1 (horizontal length Lx of the original image) (step S35), and it is determined whether a horizontal scaling ratio Nx=horizontal length X of the display area/horizontal length x of the original-image display range (step S36).

It is then determined whether a vertical scaling ratio Ny=g1 (horizontal scaling ratio Nx) (for example, vertical scaling ratio Ny=horizontal scaling ratio Nx) (step S37). Lastly, it is determined whether a vertical length y of the original-image display range: y=vertical length Y of the display area/vertical scaling ratio Ny (step S38). The vertical orientation of the original image is a range with the length y from the origin y0 and the horizontal orientation thereof is a range with the length x from the origin x0, and these ranges are set as the original-image display range. Based on this display range, the image is displayed using the vertical scaling ratio Ny and the horizontal scaling ratio Nx (step S43), and the process is ended (step S44).

If it is determined at step S31 that the image is not horizontally written (No at step S31), the image is vertically written in which it is described from the upper right to the lower left. If it is the vertically written image, then an origin (initially, at upper right coordinates) of the original-image display range is set to (x0, y0) (step S34). The process is then shifted to the change of the layout of the vertically written image, where it is determined whether the vertical length y of the original-image display range: y=f2 (vertical length Ly of the original image), for example, it is determined whether the vertical length y of the original-image display range=vertical length Ly of the original image (step S39).

It is then determined whether the vertical scaling ratio Ny=vertical length Y of the display area/vertical length y of the original-image display range (step S40). It is then determined whether a horizontal scaling ratio Nx=g2 (vertical scaling ratio Ny), for example, whether the horizontal scaling ratio Nx=vertical scaling ratio Ny (step S41).

Lastly, it is determined whether the horizontal length x of the original-image display range: x=horizontal length X of the display area/horizontal scaling ratio Nx (step S42). The vertical orientation of the original image is a range with the length y from the origin y0 and the horizontal orientation thereof is a range with the length x from the origin x0, and these ranges are set as the original-image display range. Based on this display range, the image is displayed using the vertical scaling ratio Ny and the horizontal scaling ratio Nx (step S43), and the process is ended.

As explained above, the second embodiment is configured to detect a finger contact position, to thereby detect the change of the manner of holding the device, and to control the display layout (scaling). As another embodiment, a button for display operation may be provided to control the display using the button.

For example, an operation button 22 for scaling data up or down (for instruction to display a reduced or enlarged data) may be provided as shown in FIG. 7. If this button is depressed, the layout is changed in the above manner, and is displayed. The orientation of the portrait or landscape is not changed.

It should be noted that the present invention is not limited only by the embodiments. The object of the present invention is also achieved even if the display methods are programmed respectively and the programmed methods are previously recorded in a recording medium such as a compact disk read only memory (CD-ROM).

According to an embodiment of the present invention, a display orientation of a document and an image on the electronic paper device can be automatically changed so as to be either one of the portrait orientation and the landscape orientation at which the image is easily read, depending on the manner of holding the display unit.

Furthermore, only by changing the manner of holding the electronic paper device, the display orientation (lateral display orientation) is automatically selected and displayed so that the image is easily read. It is, therefore, possible to prevent erroneous estimation and reliably control the display orientation so as to be adaptively changed for each of the various manners of holding it while the degree of freedom of a position to be held is ensured.

Moreover, the method for controlling the display of the electronic paper device, when text or the like is read on the electronic paper device, can be provided. The display method is capable of controlling the display according to a variation of contact patterns. The method of controlling the display of the electronic paper device is written into a computer program, and the method is recorded in a computer-readable information recording medium, and thus, highly repetitive, speedy, and accurate process becomes possible.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display apparatus comprising:
a display unit that includes
a first area that stretches along an outer periphery of the display unit, a plurality of sensors that senses a finger touch being arranged in the first area; and
a second area in which an image can be displayed;
a pattern determining unit that determines a pattern of the finger touch based on a sequence and a position of the finger touch obtained as result of sensing by the sensors; and
an orientation determining unit that determines orientation of an image to be displayed on the second area based on the pattern of the finger touch; and
a control unit that displays an image on the second area in the orientation determined by the orientation determining unit.

2. The display apparatus according to claim 1, wherein the pattern determining unit determines the pattern of the finger touch based on a position and a duration of the finger touch obtained as result of sensing by the sensors.

3. The display apparatus according to claim 1, wherein the pattern determining unit determines the pattern of the finger touch based on a position, a sequence, and a duration of the finger touch obtained as result of sensing by the sensors.

4. The display apparatus according to claim 1, wherein the control unit adjusts a size of an image to be displayed on the second area depending on the orientation determined by the orientation determining unit, and displays adjusted image on the second area.

5. The display apparatus according to claim 1, wherein the sensors are arranged only in the first area.

6. A method of displaying an image on a display apparatus, the display apparatus including a display unit that includes a first area that stretches along an outer periphery of the display unit and a second area in which an image can be displayed, the method comprising:
sensing a finger touch by a plurality of sensors that is arranged in the first area;
first determining including determining a pattern of the finger touch based on a position and a duration of the finger touch obtained as result of the sensing;
second determining including determining orientation of an image to be displayed on the display apparatus based on the pattern of the finger touch; and
displaying an image on the second area in the orientation determined at the second determining.

7. The method according to claim 6, wherein the first determining includes determining the pattern of the finger touch based on a position and a duration of the finger touch obtained as result at the sensing.

8. The method according to claim 6, wherein the first determining includes determining the pattern of the finger touch based on a position, a sequence, and a duration of the finger touch obtained as result at the sensing.

9. The method according to claim 6, wherein the displaying includes adjusting a size of an image to be displayed on the second area depending on the orientation determined at the second determining, and displaying adjusted image on the second area.

10. The method according to claim 6, wherein the sensing includes only sensing within the first area.

11. A computer program product that includes a computer-readable recording medium that stores therein a computer program that causes a computer to implement a method of displaying an image on a display apparatus, the display apparatus including a display unit that includes a first area that stretches along an outer periphery of the display unit and a second area in which an image can be displayed, the computer program causing the computer to execute:
sensing a finger touch by a plurality of sensors that is arranged in the first area;
first determining including determining a pattern of the finger touch based on a position and a duration of the finger touch obtained as result of the sensing;
second determining including determining orientation of an image to be displayed on the display apparatus based on the pattern of the finger touch; and
displaying an image on the second area in the orientation determined at the second determining.
